(19) United States
(12) Patent Application Publication
(10) Pub. No.: US 2018/0359411 A1
(43) Pub. Date: Dec. 13, 2018

(54) CAMERAS WITH AUTONOMOUS ADJUSTMENT AND LEARNING FUNCTIONS, AND ASSOCIATED SYSTEMS AND METHODS

(71) Applicant: Nixie Labs, Inc., Mountain View, CA (US)

(72) Inventors: Christoph Benedikt Kohstall, Palo Alto, CA (US); Jelena Jovanovic, Palo Alto, CA (US)

(21) Appl. No.: 15/399,531

(22) Filed: Jan. 5, 2017

Related U.S. Application Data
(60) Provisional application No. 62/278,398, filed on Jan. 13, 2016.

(51) Int. Cl. H04N 5/232

(52) U.S. Cl. CPC H04N 5/23222; H04N 5/23299; G06T 7/70; H04N 5/23296; H04N 5/23212

(57) ABSTRACT

Cameras with autonomous adjustment and learning functions and associated systems and methods are disclosed. A camera in accordance with a particular embodiment includes a system that determines a parameter of each of a plurality of existing photographs, the parameter being representative of a characteristic of each existing photograph, determines a figure of merit associated with each existing photograph, the figure of merit being representative of a price, popularity, and/or reputation of each existing photograph, and correlates the figures of merit with the parameters to determine a target parameter. A camera in accordance with another embodiment can include a system that analyzes a preview image from the camera, classifies the preview image, determines a parameter of the preview image associated with the classification, compares the parameter to the target parameter, and adjusts the camera to cause the preview image to have the target parameter.

### CROSS-REFERENCE TO RELATED APPLICATION

The present application claims priority to U.S. Provisional Patent Application No. 62/278,398, entitled “Cameras with Autonomous Adjustment and Learning Functions, and Associated Systems and Methods,” filed Jan. 13, 2016, which is incorporated herein by reference in its entirety.

### TECHNICAL FIELD

The present technology is directed generally to cameras with autonomous adjustment and/or cameras that provide feedback to a user to suggest adjustments, and associated systems and methods. The present technology is also directed generally to functions for learning such adjustments, and associated systems and methods.

### BACKGROUND

Photography is generally a subjective activity. Many factors may be involved in a photographer's decision to adjust his or her position or to adjust the settings of a camera, such as shutter speed or focal length. Some settings—such as shutter speed, focus, white balance, aperture, or ISO settings—have been automated. But the algorithms driving those automatic settings usually follow preprogrammed heuristics, such as focusing on the nearest object or adjusting shutter speed such that faces have proper exposure. In general, camera settings such as positioning and pointing (e.g., orientation) of the camera are not automated.

### BRIEF DESCRIPTION OF THE DRAWINGS

FIG. 1 illustrates a camera control loop for controlling specific parameters of a photograph in accordance with several embodiments of the present technology.

FIG. 2 illustrates a process for determining parameters of a photograph in accordance with several embodiments of the present technology.

FIG. 3 illustrates a learning camera control loop for autonomously adjusting a camera based on particular target parameters in accordance with several embodiments of the present technology.

FIG. 4 illustrates a photography system in accordance with several embodiments of the present technology.

FIG. 5 illustrates various devices that may be used for implementing a learning process and/or a camera control loop in accordance with several embodiments of the present technology.

FIGS. 6A, 6B, 6C, and 6D illustrate examples of adjustments to pointing and positioning or other suitable adjustments in accordance with several embodiments of the present technology.

### DETAILED DESCRIPTION

The presently disclosed technology is directed generally to cameras with autonomous adjustment and/or cameras that provide feedback to a user to suggest adjustments, and associated systems and methods. The present technology is also directed generally to functions for learning such adjustments, and associated systems and methods. In particular embodiments, a system having a camera control loop controls specific parameters of a photograph by observing a scene, analyzing the scene, and adjusting the camera based on target parameters (e.g., pre-identified and/or optimal parameters) determined from heuristics and/or analysis of an existing collection of photographs. In other embodiments, a learning function analyzes a collection of photographs to correlate characteristics or parameters of the photographs with figures of merit related to the photographs, such as price or popularity, to determine what constitutes a target parameter for a photograph. In yet other embodiments, the learning function analyzes photographs from the camera in the camera control loop to provide feedback to the system that facilitates adjusting, evolving, or otherwise updating the target parameters.

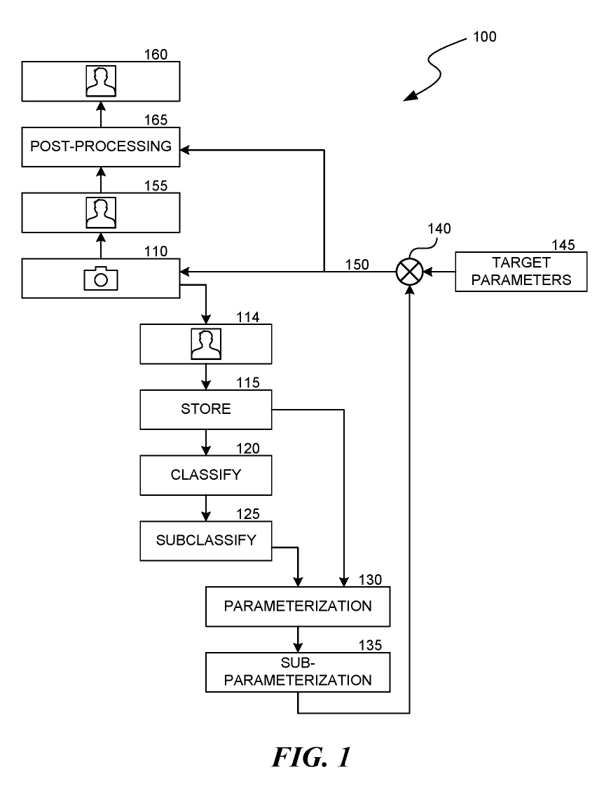

Specific details of several embodiments of the disclosed technology are described below with reference to photographs of a person based on a position of the person's face to provide a thorough understanding of these embodiments. In other embodiments, the autonomously adjusting and learning cameras can perform autonomous parameter selection for photographs of other subjects or numbers of subjects using other parameters. As used herein, the terms “photograph” and “video” can include all suitable types of media, such as, for example, digital media, film media, streaming media, and/or hard copy media. And as used herein, the terms “image” and “photograph” are interchangeable, but for convenience of description, the term “photograph” may generally be used to refer to the output of a camera control loop or the input to a learning process. Several details describing structures or processes that are well-known and often associated with cameras or control systems are not set forth in the following description for purposes of clarity. Moreover, although the following disclosure sets forth several embodiments of different aspects of the disclosed technology, several other embodiments of the technology can have different configurations or different components than those described in this section. As such, the technology can have other embodiments with additional elements and/or without several of the elements described below with reference to FIGS. 1-6D.

### Camera Control Loop

FIG. 1 illustrates a representative camera control loop 100 for controlling specific parameters of a photograph according to several embodiments of the present technology. The camera control loop 100 can be implemented on one or more computers, processors, or other systems suitable for performing computing routines. In particular embodiments, as described in additional detail below, the camera control loop 100 can be implemented on or in an unmanned aerial vehicle (UAV).

In operation, a camera 110 observes a scene that can include one or more subjects, such as one or more people, animals, elements of nature, landmarks, and/or landscapes. The camera may be tiltable, rotatable, repositionable, and/or otherwise movable via motors, actuators, or other suitable movement devices. For example, the technology can be implemented on or in a moving platform such as a motorized tripod or an unmanned aerial vehicle (UAV). In such an implementation, the technology can direct the moving platform to a target position and orientation to capture an image with target camera settings. For example, in addition to moving or repositioning via the movement devices or via the moving platform, the camera can have a flash to control lighting and/or a zoom lens for adjusting focal length. In some embodiments, zooming or focusing can be performed mechanically and/or digitally.

The camera 110 captures a preview image 114 of the scene (e.g., a single image or a portion of a real-time video stream). In block 115, the system implementing the control loop 100 stores the preview image 114 for analysis. The preview image 114 can be stored in digital form locally to the system or externally (e.g., in a cloud computing and/or server environment). When the preview image 114 is stored, the system analyzes the preview image 114 to determine one or more classifications of the subject matter therein. For example, the system analyzes the preview image 114 to determine whether it contains people, animals, elements of nature, landmarks, landscapes, and/or other types of subjects. In a particular embodiment, for purposes of illustration, the system can determine the presence of humans in the preview image 114 and tag or classify the preview image 114 as an image that contains humans (block 120). Each classification can include a number of sub-classifications representative of aspects of the preview image 114, such as the presence of a pair, a group, or a single subject, and the system can tag or sub-classify the preview image 114 accordingly (block 125). In a particular embodiment, for purposes of illustration, the system can determine that there is a single person in the scene of the preview image 114 (block 125). In other embodiments, the system can simultaneously and/or sequentially determine other and/or additional classifications and/or sub-classifications.

When the system has determined the classification(s) and/or sub-classification(s) of the subject in the preview image 114, the system further analyzes the preview image 114 to determine parameters (block 130) and/or sub-parameters (block 135) associated with the classes or sub-classes of the subject in the preview image 114. In a particular embodiment, for purposes of illustration, if the sub-classification is that the subject is a single person, the system can analyze the preview image 114 to determine the parameters representing the distance to the person (e.g., by analyzing sub-parameters such as the size of the person or the size of the person's face), the position of the person in the frame (e.g., by analyzing sub-parameters including the height and/or lateral location of the face within the frame), and the perspective the camera has relative to the person (e.g. by analyzing sub-parameters such as the position of the horizon and/or the foreground with respect to the person, and/or the direction of lighting). In a particular embodiment, for purposes of illustration, the system can determine the vertical position of a person's face within the scene of the preview image 114. The foregoing parameter(s) and sub-parameter(s) can be represented by values such as distances, angles, fractions, or other suitable quantitative metrics, which can be stored in a memory. In some embodiments, the memory can be local to the system or it can be external, such as in a cloud computing and/or server environment.

In some embodiments, the system analyzes the preview image 114 (to determine, e.g., classifications, sub-classifications, parameters, and sub-parameters) using image analysis techniques such as edge-finding algorithms or face-detection algorithms. Edge-finding algorithms can identify boundaries and/or edges such as a horizon or part of a human. Face-detection algorithms can determine the number and position of human and/or artificial faces in the image. The system can determine the distance between the subjects and the camera based on the size of faces or objects in the image, the settings of the camera, and/or the characteristics of the camera lens(es). The system can determine the direction of lighting by comparing the brightness of one side of a face or object to the brightness of another side. In further embodiments, the system can determine characteristics based on data provided by other sensors. For example, the system can use pressure sensor data and/or Global Positioning System (GPS) data to determine position, terrain, and/or altitude (e.g. to indicate that the image is from a beach or a mountain). The system can use location data to help determine whether the photo should be adjusted to accommodate indoor or outdoor conditions or other landmarks, such as forests, oceans, cities, parks, and/or tourist destinations. The process in the camera control loop 100 can include using the time of day (e.g., via an onboard clock and/or a paired connection with a clock on a mobile device) to aid in any of the foregoing determinations. The system can use speed or motion sensors to help determine that the image is related to particular activities (e.g. sports, parties). In some embodiments, the camera may pan before moving into position for the shot to scan the scene and/or environment for more context.

The parameters representing the characteristics of the preview image 114 are communicated to a controller or other adjustment function 140. The parameters of the preview image 114 can be described as what the image “is” and what the characteristics “are.” Other input to the adjustment function 140 includes target parameters 145, which represent what the parameters “should be”. As used herein and in the context of the foregoing and the following, the term “parameters” can include a single parameter or more than one parameter.

For example, in some embodiments, the target characteristics or target parameters 145 associated with what the image should be are determined from heuristics stored on the camera 110 or retrieved from a remote source (e.g., wirelessly or via periodic firmware or software updates). Heuristics can be in the form of a file or look-up table containing photographic rules or guidelines from textbooks or pre-programmed styles. For example, heuristics for adjusting the position and size of a person's face can include the “rule of thirds” or the “golden ratio” known in the art of photography. In some embodiments, heuristics can include preferred lighting angles. In a particular embodiment for purposes of illustration, one target parameter 145 provided to the adjustment function 140 can be the desired (e.g., optimal) vertical position of a person's face within a scene.

Based on the parameters representing what the preview image 114 is and the target parameters 145 associated with a desired image style (e.g., an optimal or target image), the adjustment function 140 determines how the camera 110 should be adjusted (e.g., moved, tilted, focused, etc.). In some embodiments, the adjustment function 140 provides a control signal or control data 150 to the camera 110 so that the camera 110 can point, reposition, or otherwise adjust to match the target parameters 145 provided by the heuristics. In further embodiments, the control data 150 can also include instructions related to exposure, flash, shutter speed, aperture, ISO, white balance, focus, focal length, timing, and/or other aspects of photography.

The control loop 100 adjusts the camera 110 until the preview image 114 complies with, or is within an acceptable margin of compliance with, the target parameters 145. In a particular embodiment for purposes of illustration, the control loop 100 causes the camera 110 to tilt or reposition to orient the subject's face at the target vertical level in the image as identified by the heuristics. The system can then capture the scene (e.g., corresponding to the current preview image 114) as an intermediate image 155, which can be stored in or on media and/or a storage device. In some embodiments, the process includes post-processing the intermediate image 155 (block 165), e.g., using the control data 150, before outputting the final photograph 160. Additional refinements can include cropping, color and light balance corrections, and other suitable adjustments. Each adjustment can be associated with one or more target parameters 145. In some embodiments, the post-processing step (block 165) can be skipped, and the intermediate image 155 can be the final photograph 160.

The control loop 100 can control or adjust various parameters associated with additional classifications and sub-classifications to operate the camera 110, and it can adjust more than one parameter at a time. For example, additional parameters can include the position of the subjects (e.g., based on the size of the subject in the photo and/or the distance from the camera); the direction, color, type, and/or intensity of lighting (e.g., electric or natural); and the presence or absence of obstacles or elements in the foreground and/or background (e.g. rocks, trees, walls, etc.). Additional target classifications, parameters, or variables can be identified over time by the system or by human input.

### Learning Process

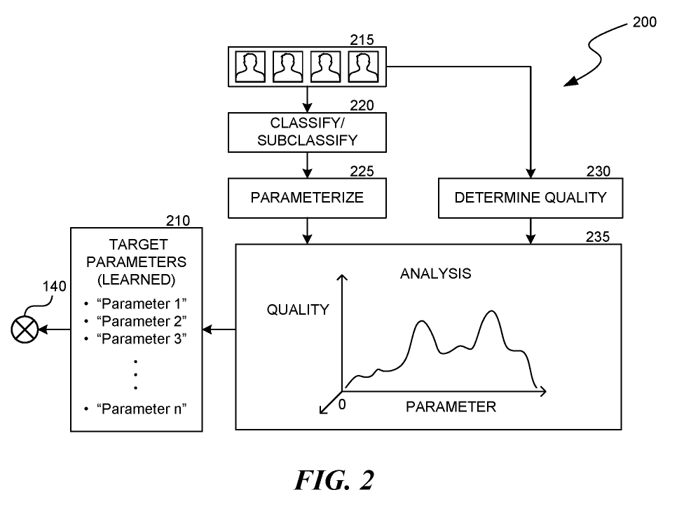

In the context of FIG. 1 described above, the target parameters 145 of what the photograph should be are provided by heuristics. In other embodiments of the technology, target parameters can be provided by a learning process or function. For example, FIG. 2 illustrates a learning process 200 for determining target parameters 210 of a photograph to provide to the adjustment function 140 (in the camera control loop 100) in accordance with several embodiments of the present technology. The learning process 200 may take place on a computer system different from the camera. For example, it may take place on a server and/or a computer located external to the camera.

The system analyzes a database 215 of existing photographs in a manner similar to the manner in which the preview image 114 is analyzed in the camera control loop 100. In some embodiments, the database of existing photographs 215 can be from a global collection in social media, an individual user's collection stored locally or in a profile on social media, photography sales platforms, and/or another suitable collection or database of photographs.

Similar to the process in the camera control loop 100, in block 220, the system analyzes each existing photograph from the existing photograph database 215 to determine classifications and then sub-classifications of each photograph, and then in block 225, the system analyzes each photograph to determine parameters and sub-parameters associated with the classifications and sub-classifications.

In a particular embodiment, for purposes of illustration, in block 220, the system can determine the presence of people in the photograph from the existing photograph database 215 and classify the photograph as one that contains people. The system can further determine that there is a single person in the scene of the photograph and sub-classify the photograph as one that has a single person. Then, in block 225, the system can determine the vertical position of the person's face within the scene of the photograph. In other embodiments, as described above, the photographs from the database 215 can be classified (block 220) and parameterized (block 225) using various other characteristics. The foregoing parameter(s) and sub-parameter(s) can be represented by values such as distances, angles, fractions, or other suitable quantitative metrics, which can be stored in a memory. In some embodiments, the memory can be local to the system or it can be external, such as in a cloud computing and/or server environment.

The system implementing the learning process 200 can also calculate a “measure of quality” (block 230) for each existing photograph from the database of photographs 215. The measure of quality is a figure of merit of the photograph. For example, if the existing photograph database 215 is an individual user's collection, the system can consider the user's tendency to view, upload, or email some pictures while ignoring others. If the existing photograph database 215 is on or from social media, the measure of quality can be based on the number of shares, the number of “likes” or “favorites”, the speed with which a photograph is shared or liked, and/or average viewing time. In some embodiments, the system can consider which photographs go “viral”. The system can determine whether a photograph has gone viral, for example, based on the photograph having been shared a number of times, or by the photograph having been shared more often than other photographs (e.g., more shares than 99% of other photographs). The system can also consider which photographs are not shared or liked and demote those photographs (e.g., calculate a lower measure of quality). If the photographs are from a database of professional photos, the measure of quality can be based on the number of downloads and/or the prices of the photographs, for example.

In a particular embodiment in which the existing photograph database 215 are from or on social media, the system can calculate quality as:

QUALITY=(Number of Likes)×(Weight Factor for Likes)+(Number of Shares)×(Weight Factor for Sharing)+(Average Viewing Time)×(Weight Factor for Viewing Time)

In the above example formula, the number of likes, the number of shares, and the average viewing time are each multiplied by an associated weight factor to increase or decrease the relative importance of each metric.

When the system has calculated the parameters and the quality of the photographs, the system applies statistical analysis (block 235) to determine the target parameters 210 that produce images having the desired measure of quality. In some embodiments, a target parameter may be the parameter value at which the quality is highest. In particular embodiments, for example, the system may correlate the vertical position of people's faces within photographs with the measure of quality calculated according to the formula above, or, for example, with a target number of likes (e.g., a maximum or threshold number of likes, or other desired number of likes) and then determine which target parameter provides the desired (e.g., maximal) quality. Such a statistical analysis can include known correlation techniques such as curve-fitting and/or simple maximum value searching, and/or smoothing followed by maximum value searching. The learning process 200 provides the target parameters 210 (representative of what the preview image 114 should be) to the adjustment function 140 of the camera control loop 100, which uses the target parameters 210 to provide the control data 150 to the camera 110.

The learning process 200 generally illustrated in FIG. 2 can be run or performed in a variety of suitable manners. For example, it can (but need not) run in real time. It can (but need not) run on the same device as the camera control loop 100 (e.g., on the camera 110 or the moving platform described above). The process can run on remote computers or servers, such as within a cloud computing environment. Data from the learning process 200 can be periodically communicated to a system or database of target parameters 210 providing the input to the adjustment function.

The results of the learning process 200 may include a set of target parameters for various classes and/or classifications of photographs. Those parameters may be stored in a look-up table, which may be updated periodically. In one embodiment, the learning process 200 is implemented on one or more computers and/or servers located remotely from the camera and the look-up table is stored and updated periodically on the camera 110 and/or in associated camera equipment. In such embodiments the computing power of the server(s) can be leveraged and the camera 110 can function without real-time connection to the server(s).

The system uses the results of the learning process 200 to direct the camera 110 to orient and operate according to, e.g., the most popular photographic styles and techniques. In a particular embodiment, the results of the learning process 200 cause the camera 110 to orient and operate to position a person's face at a target (e.g., optimal) vertical position.

### Feedback and Evolution

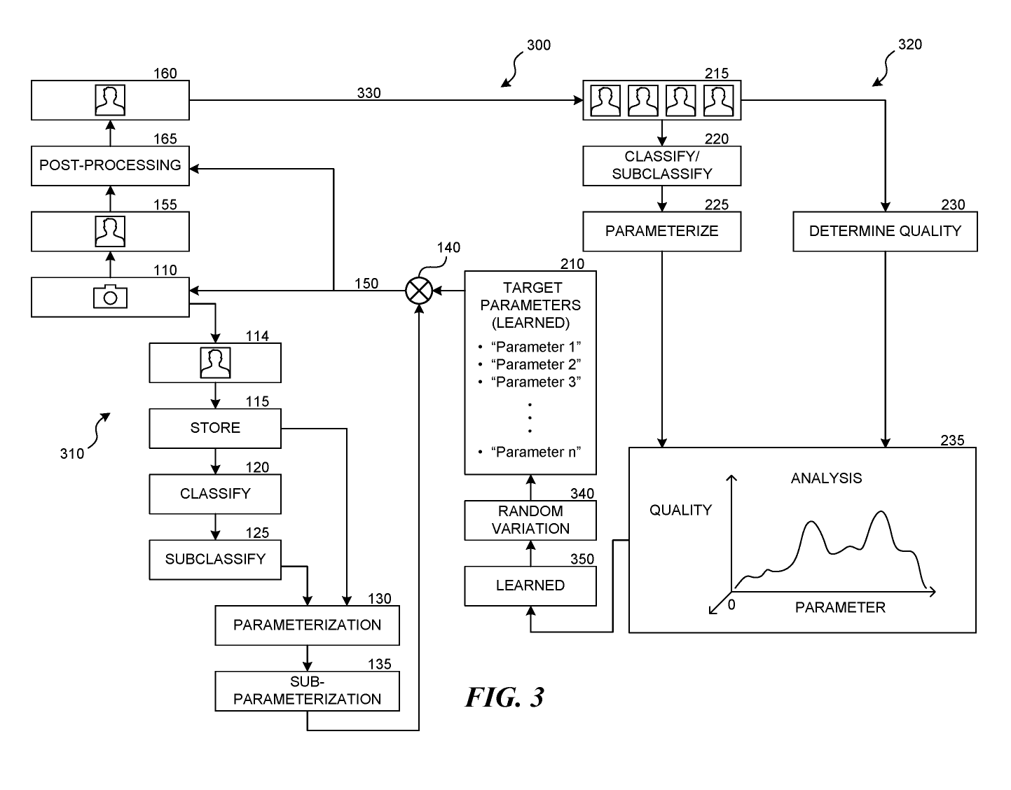

FIG. 3 illustrates a learning camera control loop 300 for autonomously adjusting a camera 110 using a control loop 310 based on target parameters determined in a learning process 320 in accordance with embodiments of the present technology. The camera control loop 310 is generally similar to the camera control loop 100 illustrated in FIG. 1 and the learning process 320 is generally similar to the learning process 200 in FIG. 2.

In some embodiments, the final photographs 160 from the camera control loop 310 are uploaded, saved, streamed, and/or otherwise provided as feedback 330 to the database of photographs 215 used by the learning process 320 for determining target parameters 210 for input in the adjusting function 140. One side-effect of such feedback 330 is that over time, the photographs in the database 215 may tend to have similar qualities.

To avoid creating a database of photographs 215 with low stylistic diversity, the system can facilitate evolution of the target parameters 210 by introducing a random variation (block 340) to the target (e.g., optimal) learned parameter 350 calculated from the statistical analysis (block 235). For example, if over time the target face position is consistently 75% of the height of the image, the random variation (block 340) can influence the camera control loop 310 to create photographs in feedback 330 that have other values, which can change the input to the learning process 320 and, in turn, continually change the target parameters 210. In this way, photographs do not all have the same parameters over time.

In other embodiments, other learning processes are implemented using other variations or other statistical analyses. In implementation, learning processes or functions can be loaded onto the camera 110 (and/or devices associated with the camera 110, such as a moving platform) as manufacturer updates or as custom processes, programs, or functions developed by or for a user.

### Applications

Embodiments of the presently disclosed technology can be implemented on a handheld camera, for example, to guide a user in positioning and orienting a camera and/or to guide the user for timing the photograph, through cues and feedback. Cues and feedback can include visual, auditory, and/or tactile feedback.

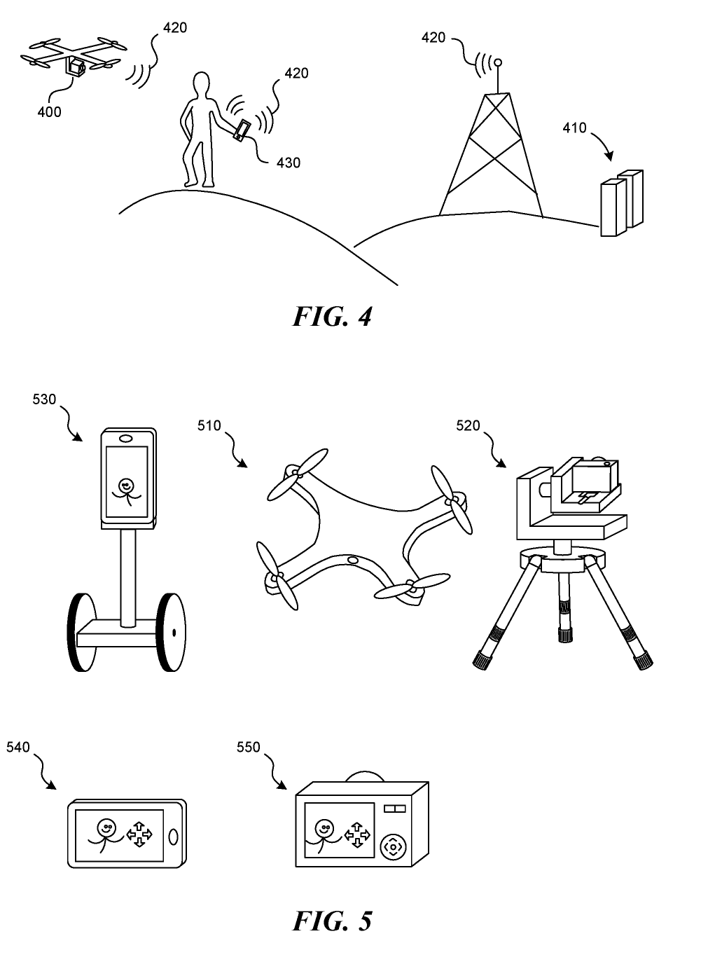

FIG. 4 illustrates a photography system in accordance with several embodiments of the present technology. The camera 400 may be mounted to an unmanned aerial vehicle (UAV) via a gimbal that may be used to adjust the orientation (e.g., pointing direction) of the camera 400. The learning process 200 (described above) to determine target (e.g., optimal) parameters may occur on servers 410. The camera 400 can receive the target parameters through a wireless connection 420 directly and/or, in some embodiments, through a smartphone functioning as a communication relay. The target parameters can also be transmitted to the camera 400 in the form of a lookup table, such that the system does not require a communications connection at the time of taking the photograph in order to operate.

FIG. 5 illustrates representative devices that can be used to implement the learning process 200 and/or the camera control loop 100 in accordance with several embodiments of the present technology. Devices 510, 520, and 530 can have the ability to autonomously adjust their position and/or orientation. For example, a UAV 510 can be used to autonomously adjust the position and orientation, including, for example, vertical pointing facilitated by mounting the camera on a gimbal. A motorized tripod 520 can also be used to autonomously adjust orientation. A tele-presence robot can also facilitate various degrees of positioning and orientation. In some embodiments of the present technology, cameras in smartphones 540 and/or traditional cameras 550 can provide feedback to a user regarding how to adjust his or her position and/or the orientation of the camera.

In a UAV implementation, the UAV automatically detects the context of the picture it is to take and adjusts its position and the timing of the picture on that basis. For example, the UAV may move to a different field of view for a single portrait than for a group shot or it may use different timing if waiting for a subject to smile than if taking candid shot. In such embodiments, the system includes smile recognition software.

In a particular example, as described above, the system uses the learning process to gather images, from social media, that depict a single person. For each image, the number of “likes” or “favorites” of the image is correlated with the position of the person's face between the top and bottom of the image. The system performs an inverted parabola or other statistical curve-fitting analysis to determine the target (e.g., optimal or most popular, for example) position of the person's face based on the maximum number of likes. The camera control loop retrieves the target position and adjusts the position and/or orientation of the camera to capture an image of a person with the person's face in the optimal position and output the image as a final photograph.

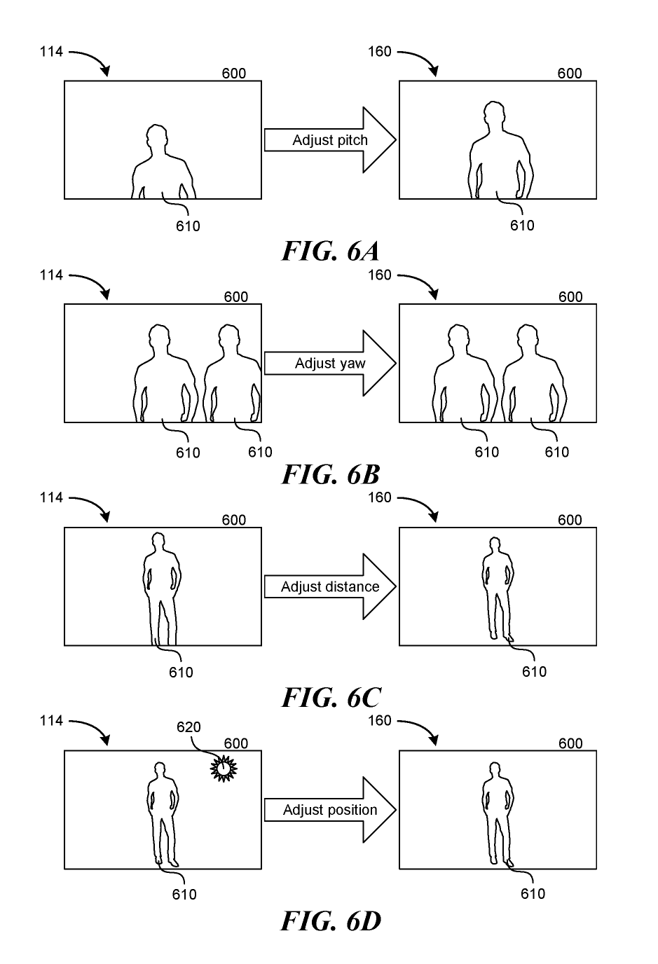

FIGS. 6A, 6B, 6C, and 6D illustrate examples of adjustments to pointing, positioning, focusing, and/or other parameters in accordance with several embodiments of the present technology. Referring to FIG. 6A, a preview image, such as the preview image 114 described above (or another image captured prior to adjustment according to embodiments of the present technology), may be positioned in a frame 600 such that a subject 610 is too low or too high relative to one or more desired target parameters (e.g., in the form of heuristics 145 or learned parameters 210 described herein). Embodiments of the present technology can adjust the image, for example, by physically changing a pitch angle of the camera (such as by aiming the camera 110 up or down) and/or by post-processing (such as via the intermediate image 155 described above). A resulting image (such as the final photograph 160 described above) may be positioned in the frame 600 according to the target parameters, such as the “rule of thirds” or the “golden ratio.”

FIG. 6B illustrates adjusting a yaw angle of a camera (e.g., aiming the camera left or right) such that a subject 610 (for example, a group of subjects) is centered in the frame 600. FIG. 6C illustrates adjusting a camera distance, a focal length, and/or image cropping to capture the entirety of a subject 610. FIG. 6D illustrates repositioning or other suitable adjustment to change an angle of backlighting 620. Other suitable adjustments and combinations of adjustments based on heuristics or learned parameters to improve an image can be implemented.

Reference in the present disclosure to “one embodiment” or “an embodiment” means that a particular feature, structure, or characteristic described in connection with the embodiment is included in at least one embodiment of the disclosed technology. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others. Similarly, various requirements are described which can be requirements for some embodiments, but not for other embodiments.

From the foregoing, it will be appreciated that specific embodiments of the disclosed technology have been described herein for purposes of illustration, but that various modifications may be made without deviating from the technology. For example, in some embodiments, the camera 110 may contain and/or run the camera control loop (e.g., 100, 310), or the camera control loop and the data used for the adjusting function 140 can be stored and performed remotely and transmitted to the camera 110. The preview image 114 can be transmitted for remote processing. In some embodiments, the target parameters (e.g., in the form of heuristics 145 or learned parameters 210) can be obtained from software or hardware onboard professional cameras that monitors the behavior of professional photographers. In some embodiments, the systems and methods described herein can be used for improving and/or optimizing videography based on videos in a video database or heuristics. Many other suitable classifications and parameters can be used to control the position, orientation, and/or settings of the cameras, such as timing of a photo and exposure control. In some embodiments, a user can select between controlling the camera with heuristics (e.g., as generally illustrated in FIG. 1) and controlling the camera with learned properties (e.g., as generally illustrated in FIGS. 2 and 3). In some embodiments, target parameters need not be the most popular or optimal parameters, and they can be less popular or less desirable parameters.

Certain aspects of the technology described in the context of particular embodiments may be combined or eliminated in other embodiments. For example, the use of feedback 330 and/or post-processing 165 may be omitted in some embodiments.

Further, while advantages associated with certain embodiments of the disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method for taking a picture comprising:
determining a parameter of each of a plurality of existing photographs, the parameter being representative of a characteristic of each existing photograph;
determining a figure of merit associated with each existing photograph, the figure of merit being representative of a price, popularity, and/or reputation of each existing photograph;
correlating the figures of merit with the parameters to determine a target parameter; and
adjusting a camera to the target parameter.

2. The method of claim 1 wherein adjusting a camera to the target parameter comprises at least one of tilting, rotating, repositioning, focusing or zooming.

3. The method of claim 1 wherein adjusting a camera to the target parameter comprises:
analyzing a preview image generated by the camera, wherein analyzing the preview image comprises determining an initial parameter representative of a characteristic of the preview image;
comparing the initial parameter to the target parameter; and
adjusting the camera to cause the preview image to have the target parameter.

4. The method of claim 3 wherein the initial parameter comprises at least one of a distance to a subject, a size of the subject, a position of the subject in the preview image, or a lighting angle relative to the subject.

5. The method of claim 1 wherein adjusting a camera to the target parameter comprises:
analyzing a preview image, wherein analyzing the preview image comprises determining a classification of the preview image and determining at least one initial parameter of the preview image associated with the classification;
comparing the at least one initial parameter to the target parameter; and
adjusting the camera to cause the preview image to have the target parameter.

6. The method of claim 5 wherein the classification comprises at least one of a type of subject or a quantity of subjects.

7. A method for taking a picture comprising:
analyzing a preview image generated by a camera, wherein analyzing the preview image comprises determining at least one initial parameter representative of a characteristic of the preview image;
comparing the at least one initial parameter to a target parameter; and
adjusting the camera to cause the preview image to have the target parameter.

8. The method of claim 7 wherein the initial parameter is representative of at least one of a distance to a subject, a position of the subject in the preview image, or a lighting angle relative to the subject.

9. The method of claim 7 wherein adjusting the camera comprises at least one of tilting, rotating, or repositioning.

10. The method of claim 7 wherein adjusting the camera comprises operating a moving platform supporting the camera.

11. The method of claim 10 wherein adjusting the camera comprises operating an unmanned aerial vehicle (UAV) carrying the camera.

12. The method of claim 7 wherein:
analyzing the preview image further comprises determining a classification of the preview image; and
the at least one initial parameter is associated with the classification.

13. The method of claim 12 wherein the classification comprises at least one of a type of subject or a quantity of subjects.

14. The method of claim 7, further comprising capturing an intermediate image and adjusting the intermediate image based at least in part on the target parameter.

15. The method of claim 7, further comprising determining the target parameter, wherein determining the target parameter comprises:
retrieving a photograph from a database;
determining a second parameter, the second parameter being representative of a characteristic of the photograph; and
assigning the second parameter to be the target parameter.

16. The method of claim 7, further comprising determining the target parameter, wherein determining the target parameter comprises:
determining an existing parameter of each of a plurality of existing photographs, each existing parameter being representative of a characteristic of each existing photograph;
determining a figure of merit associated with each existing photograph, the figure of merit being representative of a price, popularity, and/or reputation of each existing photograph;
correlating the figures of merit with the existing parameters; and
selecting, by a computer system, the target parameter based on the correlation of the figures of merit with the existing parameters.

17. A system for taking a picture comprising:
a camera;
a moving platform carrying the camera, the moving platform being configured to move the camera relative to a subject; and
a controller programmed with instructions that, when executed, cause the moving platform to perform a method comprising:
generating a preview image using the camera;
analyzing the preview image, wherein analyzing the preview image comprises determining a first parameter of the preview image;
comparing the first parameter to a target parameter; and
adjusting the camera to cause the preview image to have the target parameter.

18. The system of claim 17, further comprising:
a processor programmed with instructions that, when executed:
retrieve at least one photograph from a database;
determine a second parameter, the second parameter being representative of a characteristic of the at least one photograph; and
assign the second parameter to be the target parameter.

19. The system of claim 17, further comprising:
a processor programmed with instructions that, when executed:
determine a plurality of second parameters, each second parameter being representative of a characteristic of a photograph in a database;
determine a figure of merit associated with each photograph in the database, the figure of merit being representative of a price, popularity, and/or reputation of each photograph;
correlate the figures of merit with the second parameters; and
select one of the second parameters to be the target parameter based on the correlation of the figures of merit with the second parameters.

20. The system of claim 17 wherein the moving platform is an unmanned aerial vehicle (UAV), and wherein adjusting the camera comprises moving the UAV.
